(19) United States
(12) Patent Application Publication
(10) Pub. No.: US 2004/0239765 A1
(43) Pub. Date: Dec. 2, 2004

(54) Photographed image transmitting apparatus

(75) Inventor: Tetsuya Kuromatsu, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/835,050

(22) Filed: Apr. 28, 2004

(30) Foreign Application Priority Data
May 29, 2003 (JP) 2003-152583

(51) Int. Cl. H04N 5/225

(52) U.S. Cl. 348/207.1

(57) ABSTRACT

When a photographed image which has been photographed by a camera is transmitted, a portable terminal equipped with such a camera is capable of transmitting the photographed image to a transmission destination thereof in a proper manner, while a user need not perform a specific operation as to this portable terminal equipped with the camera. Under such a condition that a CPU stores/manages a registration record in which images of persons have been registered in correspondence with mail addresses every person, in such a case that the CPU analyzes a photographed image photographed by a camera apparatus so as to recognize that an image of a person as a transmission subject is contained in this analyzed photographed image, the CPU transmits the recognized photographed image to such a mail address corresponding to the relevant person in the mail form.

### BACKGROUND OF THE INVENTION

1. Field of the Invention

The present invention generally relates to a photographed image transmitting apparatus and a program, capable of transmitting a photographed image. More specifically, the present invention is directed to such a photographed image transmitting apparatus and a computer readable program, capable of transmitting photographed images photographed by a camera to properly-selected transmission destinations without requiring specific operations.

2. Description of the Related Art

Very recently, since camera apparatus using CCD image sensors, or the like as imaging elements are popularized as well as the Internet and broadband communication environments are practically established, even when information processing terminals such as PDAs (personal digital assistants) and portable telephone are employed, various images photographed by camera apparatus can be freely transmitted and/or downloaded. Also, while there are many utilizing purposes as to photographed images, remote monitoring operations are available by monitoring images taken by photographing actual fields.

For instance, conventionally, such a remote monitoring system is known in this technical field. That is, since such a photographed image acquired by photographing an interior of an office by operating a monitor camera is analyzed, a person (namely, suspicious person) photographed in this analyzed photographed image is detected, and then, such an electronic mail indicative of presence of such a suspicious person is transmitted to a portable telephone.

On the other hand, in such a case that photographed images (photographs) taken by a digital still camera are attached to electronic mails and then the electronic mails attached with the photographed images are transmitted to a communication counter party, a photograph of a transmission subject is searched from a large number of photographs which have already been acquired, and/or a transmission destination address (namely, mail address) is searched from an address notebook and thus the electronic mail attached with the photograph is transmitted to this mail address. For instance, in such a case that a plurality of persons are photographed as a group memorial photograph, a user must search the respective mail addresses while the user sequentially confirms that which person has been photographed. Also, even in such a case that the same person has been photographed many times, a user is required to seek a subject photograph from a large number of acquired photographs and also to find out a mail address of this person every time an electronic mail attached with a photograph is transmitted. As a result, the conventional system necessarily requires such a cumbersome operation, and also, owns such a problem. That is, there are many possibilities that the user forgets to send the electronic mails attached with the photographs.

This technical aspect may cause a similar problem even in such a case that a color-printed photographed image is transmitted by operating a facsimile apparatus.

### SUMMARY OF THE INVENTION

The present invention has been made to solve the above-explained problems of the prior art, and therefore, has a first object to provide a photographed image transmitting apparatus by which when a photographed image acquired by a camera is transmitted, the photographed image can be properly transmitted to a desirable transmission destination, while a specific operation is not required.

A second object of the present invention is to provide such a photographed image transmitting apparatus by which when a photographed image acquired by a camera is transmitted, the photographed image can be properly transmitted to a desirable transmission destination by merely designating this transmission destination.

The first object of the present invention can be achieved by such a photographed image transmitting apparatus for transmitting a photographed image which is photographed by a camera, comprising: registration information storage means for storing/managing an image of a previously registered photographic object in correspondence with a transmission destination thereof every said previously registered photographic object; image recognizing means for recognizing as to whether or not the previously registered photographic object image is contained in the photographed image by analyzing the photographed image; and transmission means for transmitting the photographed image to the transmission destination which has been registered in correspondence with the photographic object image in such a case that the image recognizing means recognizes that the photographic object image is contained in the photographed image.

The second object of the present invention can be achieved by such a photographed image transmitting apparatus for transmitting a photographed image which is photographed by a camera, comprising: registration information storage means for storing/managing an image of a previously registered photographic object in correspondence with a transmission destination thereof every the previously registered photographic object; extraction means operated in such a manner that when a transmission destination of a photographed image is arbitrarily designated during a transmission of an electronic mail, such a photographed image is extracted which contains the photographic object image registered in correspondence with the designated transmission destination; and mail transmission means for transmitting the electronic mail attached with the photographed image which is extracted by the extraction means to the designated transmission destination.

In accordance with a first aspect of the present invention, in such a case that the photographed image is analyzed and such a confirmation is made that the registered photographic object image is contained in the analyzed photographed image, since this photographed image is transmitted to the transmission destination which has been registered in correspondence with this photographic object image, the photographed image can be properly transmitted to the transmission destination without executing the specific operation, and such a cumbersome operation is no longer required, and furthermore, it is possible to avoid to forget the transmitting operation of the photographed image. In this cumbersome operation, while the user confirms that what images have been photographed as to each of the photographed images, the user searches the respective mail addresses relevant to these images.

In accordance with a second aspect of the present invention, when the destination of the photographed image is arbitrarily designated while the electronic mail is transmitted, such a photographed image is extracted which contains the photographic object image which has been registered in correspondence with this arbitrarily designated transmission destination, and then, the extracted image is transmitted to the designated transmission destination in the mail form. As a consequence, this photographed image can be properly transmitted to the designated transmission destination by merely and arbitrarily designating the transmission destination. Also, the photographed image transmitting apparatus can avoid such a cumbersome work that while the user confirms that what image has been photographed every photographed image, the user must fine out the respective transmission destinations.

### BRIEF DESCRIPTION OF THE DRAWINGS

For a better understanding of the present invention, reference is made of a detailed description to be read in conjunction with the accompanying drawings, in which:

FIG. 1 is a schematic block diagram for indicating a basic structural element of a portable terminal equipped with a camera, according to a first embodiment of the present invention;

FIG. 2A is a diagram for illustratively showing a content of a registration record “RT” which constructs a registration database of the first portable terminal equipped with the camera indicated in FIG. 1;

FIG. 2B is a diagram for illustratively showing a content of an image file “GF”;

FIG. 2C is a diagram for illustratively representing a content of a transmission record “AD” which constitutes a transmission database of the first portable terminal of FIG. 1;

FIG. 3 is a flowchart for describing a process operation of the first portable terminal of FIG. 1 as to camera photographing operations and mail transmissions of photographed images;

FIG. 4 is a flowchart for explaining a process operation continued to the flow chart of FIG. 3;

FIG. 5 is a flow chart for explaining a process operation contained to the flow charts of FIG. 3 and FIG. 4;

FIG. 6A is a diagram for illustratively showing a content of a registration record “RT” which constructs a registration database of the second portable terminal equipped with the camera;

FIG. 6B is a diagram for illustratively representing a content of a transmission record “AD” which constitutes a transmission database of the second portable terminal;

FIG. 7 is a flow chart for describing a process operation of the second portable terminal as to camera photographing operations and mail transmission of photographed images; and

FIG. 8 is a flow chart for explaining a process operation continued to the flow chart of FIG. 7.

### DETAILED DESCRIPTION OF THE PREFERRED EMBODIMENTS

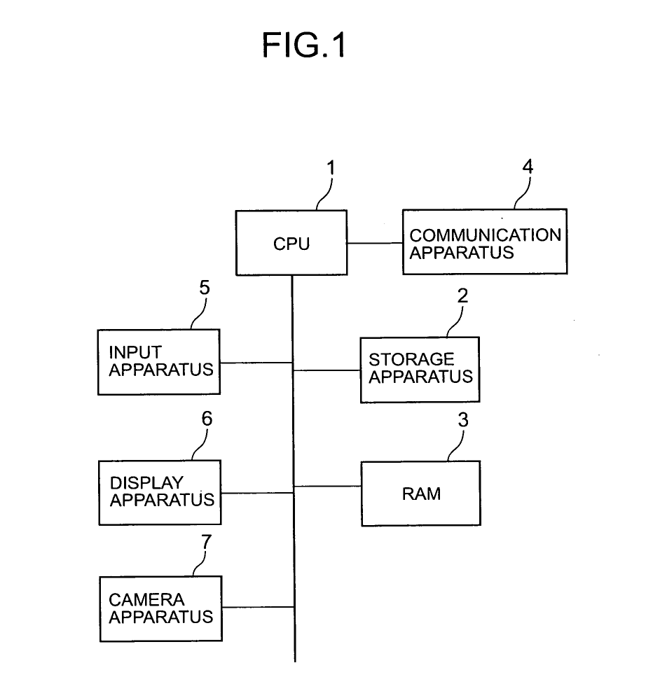

Referring now to FIG. 1 to FIG. 5, a description is made of a portable terminal equipped with a camera, according to a first embodiment of the present invention.

Basic Structural Elements of First Portable Terminal Equipped With Camera

FIG. 1 is a schematic block diagram for indicating basic structural elements of the portable terminal equipped with the camera, according to the first embodiment of the present invention.

It should be understood that this portable terminal equipped with the camera corresponds to such a portable terminal as a portable telephone equipped with a camera, a PDA (Personal Digital Assistant), and the like, and is connected to a transmission destination terminal (not shown) via a network (e.g., ground system/satellite system mobile communication network and Internet network). In this first embodiment, for instance, photographed images which have been digitally processed (processed in data packet form) are transmitted/received between the first portable terminal equipped with the camera and the transmission destination terminal by way of, for example, an HTTP protocol using a TCP/IP communication protocol.

Before describing featured portions of this first embodiment in detail, a hardware structure of this first embodiment will be now be described.

In FIG. 1, a CPU 1 is a central processing unit for controlling entire operations of this first portable terminal equipped with the camera in accordance with an operating system (OS) and various sorts of application software, which have been stored in a storage apparatus 2. The storage apparatus 2 contains a program storage area and a data storage area, and is constituted by a magnetic memory, an optical memory, or a semiconductor memory, and a drive system thereof. Alternatively, this storage apparatus 2 may be constituted by an apparatus capable of mounting thereon a fixed type memory such as a hard disk, and a detachable storage medium such as a CD-ROM and a DVD. Programs and data stored in this storage apparatus 2 may be loaded to a RAM (for example, static RAM) 3 if necessary, and data stored in the RAM 3 may be saved to the storage apparatus 2. It should also be noted that the RAM 3 owns both a program execution area and a work area.

On the other hand, input/output peripheral devices are connected via a bus line to this CPU 1, namely, a communication apparatus 4, an input apparatus 5, a display apparatus 6, and a camera apparatus 7 are connected through the bus line to the CPU 1. Thus, the CPU 1 controls operations of these input/output peripheral devices in accordance with an input/output program. The input apparatus 5 is provided with a specific photographic mode button, an image registering button, a transmission setting button, a transmission button and the like, which are employed as buttons specific to this first embodiment, in addition to various sorts of buttons such as a shutter button, which are normally equipped. The camera apparatus 7 corresponds to a digital still camera which uses a CCD image sensor, or the like as an imaging element, while photographed images (color images) which have been photographed by this camera apparatus 7 are stored in the stored apparatus 2, and further, are attached to electronic mails, so that the photographed images attached with the electronic mails are transmitted to transmission destination terminals.

Record Contents of Databases

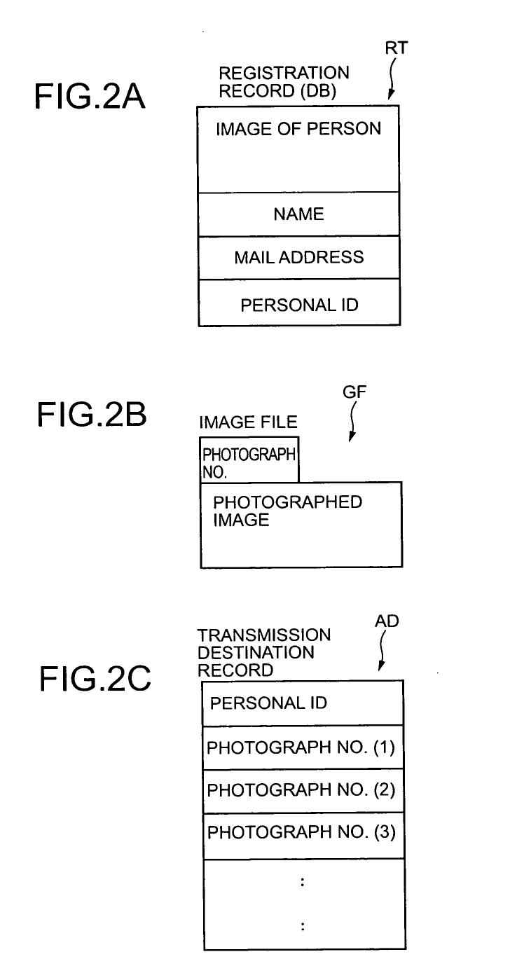

FIG. 2A is a diagram for illustratively showing a content of a registration record “RT” which constructs a registration database of the first portable terminal equipped with the camera indicated in FIG. 1. FIG. 2B is a diagram for illustratively showing a content of an image file “GF.” FIG. 2C is a diagram for illustratively representing a content of a transmission record “AD” which constitutes s transmission database of the first portable terminal.

The registration record RT stores and manages images of photographic objects (persons) and transmission destinations in correspondence with each other with respect to each of the photographic objects which have been previously registered. The registration record RT owns respective items of “personal image”, “name”, “mail address”, and “personal ID” every person. These items of “personal image”, “name”, and “mail address” have been arbitrarily read out from a transmission destination mail address notebook (not shown in detail) and then have been set to the registration record RT. The item of “personal image” corresponds to such a face image which has been photographed while a face of this person is set to a central point thereof. The item of “personal ID” corresponds to person identification information (registration record identification information) which is issued every time the registration record RT is produced.

The image file GF stores and manages the respective photographed images which have been photographed in an 1-image/1-file form. This image file GF is constructed in such a manner that the respective photographed images are stored and managed in correspondence with photograph No. (serial number) which is updated every time photographic operation is carried out.

The transmission destination record AD classifies and manages the respective photographed images every personal ID. This transmission destination record AD is constituted in such a manner that a plurality of “photograph No.” can be stored in correspondence with the item “personal ID.” In this embodiment, the first portable terminal equipped with the camera recognizes as to whether or not the item “personal image” contained in the registration record RT is contained in a photographed image by analyzing the photographed image. If the registration image is contained in this photographed image, then the portable terminal sets “photograph No.” thereof to the transmission destination record AD in correspondence with this “personal ID.” Also, the portable terminal equipped with the camera accesses the image file GF based upon each of “photograph No.” contained in the transmission destination record AD so as to read the relevant photographed image, and also, accesses the registration record RT based upon “personal ID” contained in the transmission destination record AD so as to read the relevant “mail address”, and then, transmits the respective photographed images to this read “mail address.”

Conceptional Operation of First Portable Terminal

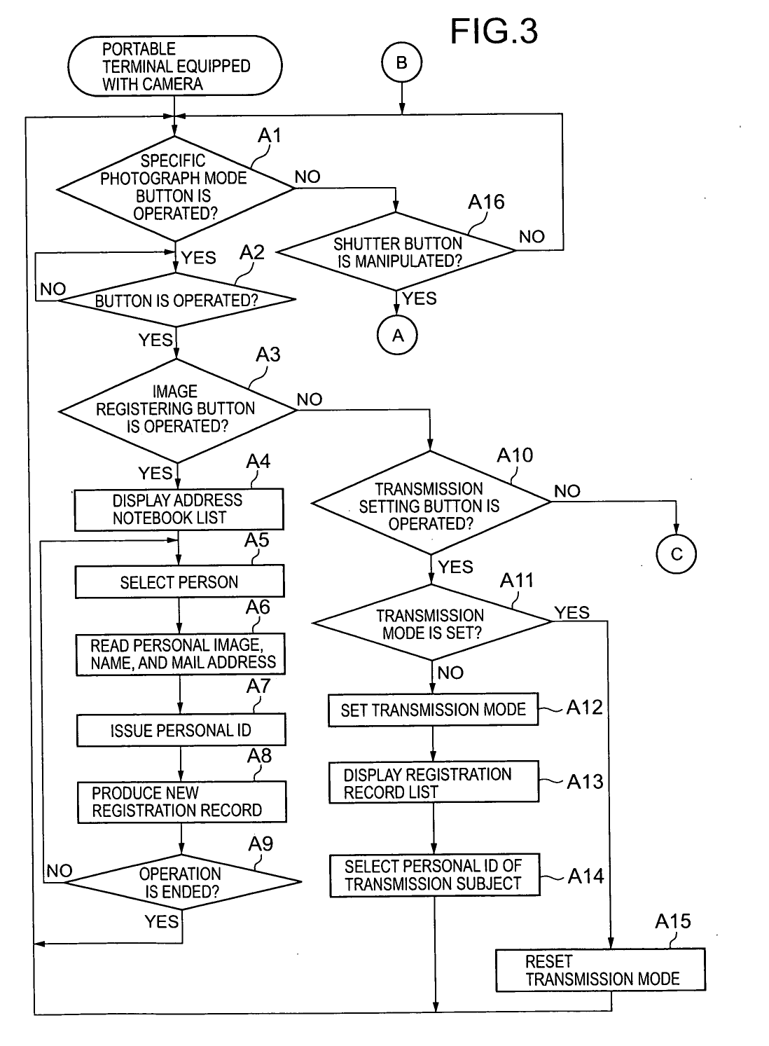

Next, a conceptional operation of the portable terminal equipped with the camera according to this first embodiment will now be explained with reference to flow charts shown in FIG. 3 to FIG. 5. It should also be noted that while the respective functions described in these flow charts have been stored in the form of computer readable program codes, the portable terminal equipped with the camera sequentially executes operations in accordance with the program codes. Alternatively, the portable terminal equipped with the camera may sequentially execute operations in accordance with the above-explained program codes which have been transferred via a transfer medium. This fact may be similarly applied to other embodiments (will be explained later). Thus, portable terminal equipped with the camera may also execute operations specific to this embodiment by utilizing programs/data which are externally supplied from a recording medium, or a transfer medium.

Camera Photographing Operatin and Mail Transmitting Operation of Photographed Image

FIG. 3 to FIG. 5 are flow charts for describing process operations related to a camera photographing operation and a mail transmitting operation of a photographed image in the first embodiment.

First, the CPU 1 checks as to whether or not a button for changing a camera mode from the normal photographic mode to the specific photographic mode is manipulated (step A1) In such a case that the specific photographic mode is manipulated, the CPU 1 checks as to whether or not another button is manipulated (step A2). It should also be noted that this specific photographic mode is repeatedly set/reset every time the specific photographic mode button is operated. In this case, in the specific photographic mode, when any one of the image registering button, the transmission setting button, and the transmission button is manipulated (“YES” in step A2), if this operation button is the image registering button (step A3), then the CPU 1 displays contents of a transmission destination mail address notebook in a list form (step A4).

In such a case that an arbitrary person is selected and designated from this transmission destination mail address list (step A5), the CPU 1 reads out the items of “personal image”, “name”, and “mail address” corresponding to this designated person from this address notebook (step A6), and produces/issues the item of “personal ID” (step A7) Then, the CPU 1 produces a new registration record “RT” which contains these items of “personal image”, “name”, “mail address”, and “personal ID”, and then stores/manages this new registration record RT (step A8). Subsequently, the above-explained registration record producing process operation (steps A5 to A9) is repeatedly carried out every 1 record until a registration completion is instructed (step A9).

In the case that the transmission setting button is manipulated under such a condition that the respective registration records corresponding to the persons have been produced/managed in the above-described manner (step A10), the CPU 1 checks as to whether or not the present operation mode has been set to the transmission mode (step A11). This transmission mode corresponds to such an operation mode that the portable terminal equipped with the camera is set to such a condition that a photographed image can be transmitted. This transmission mode is repeatedly set/reset every time the transmission setting button is manipulated. Now, in such a case that the transmission setting button is manipulated under such a condition that the present operation mode has been set to the transmission mode, the transmission mode is reset (step A15), whereas in such a case that the transmission setting button is manipulated under such a condition that the present operation mode has been reset to the transmission mode, the transmission mode is set (step A12), and also, the list of the registration record RT is displayed (step A13) Then, in such a case that an arbitrary person is selected/designated as a transmission subject from this list, an item of “personal ID” which is read out from this registration RT is temporarily stored (step A14). In this case, a plurality of persons may be alternatively designated as transmission subjects namely, there is no limitation as to a total number of selectable persons.

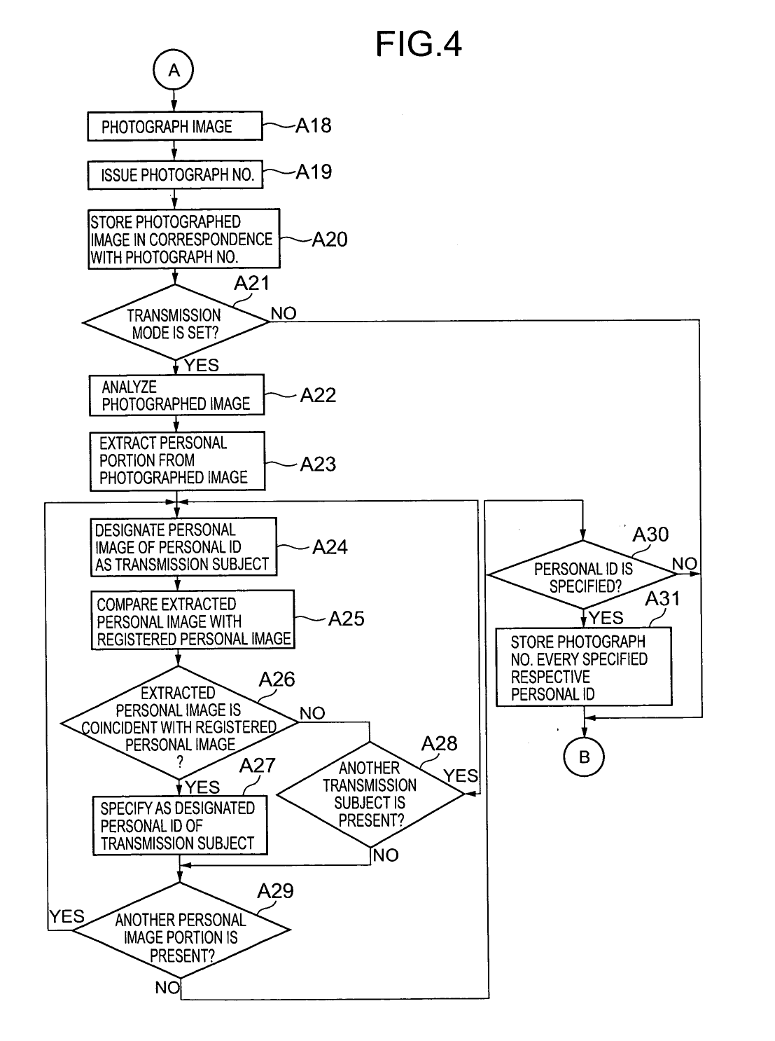

On the other hand, under such a condition that the above-described specific photographic mode is released (reset), when the shutter button is manipulated (step A16), an image photographing operation is carried out in response to this shutter button (step A17 of FIG. 4), and the photograph No. is updated to issue a new photograph No. (step A18), and then, the photographed image to which this new photograph No. has been attached is saved as an image file GF (step A19). Then, the CPU 1 checks as to whether or not the transmission mode has been set (step A20). When this transmission mode has been reset, the process operation is returned to the first step A1 of FIG. 3, whereas when the transmission mode has been set, this photographed image is analyzed (step A22) so as to extract a personal portion contained in the photographed image (step A23). In this case, such a personal image that a face of the person is located at a center is extracted.

After the personal image as to one person has been extracted from the photographed image in this manner, the CPU 1 accesses the registration record RT based upon the personal ID which has been selected/designated as the transmission subject in the above-explained step A14 so as to read out the relevant personal image from this registration record RT (step A24). Then, the CPU 1 compares the personal image extracted from the photographed image with the personal image read from the registration record RT (step A25). In this case, the CPU 1 executes image comparing operations in accordance with the below-mentioned manner. That is, the image comparing operations are separately carried out between the extracted personal image and the read personal image with respect to shapes, positions, and sizes as to face contours, eyes, mouths, noses, foreheads, and the like; and with respect to hairstyles, presence/absence of glasses, sorts of glasses, and the like. Alternatively, the CPU 1 may execute the image comparing operations with respect to all of the above-described comparison subjects in a comprehensive manner.

As a result of this comparison, when the extracted personal image is made coincident with the read personal image as to the featured portion (“YES” in step A26), the CPU 1 specifies this personal ID as the transmission subject (step A27). To the contrary, when the extracted personal image is not made coincident with the read personal image as to the featured portion (“NO” in step A26), the CPU 1 checks as to whether or not any other persons are present in the extracted photographed image as the transmission subject (step A28) In such a case that a plurality of persons have been selected/designated as the transmission subjects in the above-described step A14, the CPU 1 checks as to whether or not image comparing operations as to featured portions of both personal images are carried out with respect to all of the remaining transmission subject persons. If there is a transmission subject which has not yet be checked in the image comparing operation, then the process operation is returned to the previous step A24, and the above-explained image comparing operations are repeatedly carried out. As a result of these image comparing operations, when any one of these transmission subject persons is made coincident with the read personal image, the CPU 1 specifies a personal ID of this transmission subject person as the transmission subject (step A27).

Since the photographed image is further analyzed, the CPU 1 checks as to whether or not another personal image is contained in the photographed image (step A29). In such a case that a plurality of persons have been photographed in this photographed image, the process operation is returned to the previous step A23. In this step A23, the CPU 1 extracts a personal image portion as to one person other than the above-extracted person, and thereafter, repeatedly carriers out the above-described process operations. As a result, when the comparing process operations are accomplished with respect to all of the persons which have been photographed in this photographed image (“NO” in step A29), the CPU 1 checks as to whether or not a specified personal ID is present (step A30). In the case that even one relevant person is present, the CPU 1 sets the photograph No. thereof to the record content of the corresponding personal ID within the transmission destination record AD with respect to each of the specified personal IDs (step A31). In this case, when the transmission destination record AD of the specified personal ID is present (namely, has already been formed), this photograph NO. is additionally registered in the relevant record AD. To the contrary, when the relevant record AD is not present, a transmission destination record AD of the specified personal ID is newly formed.

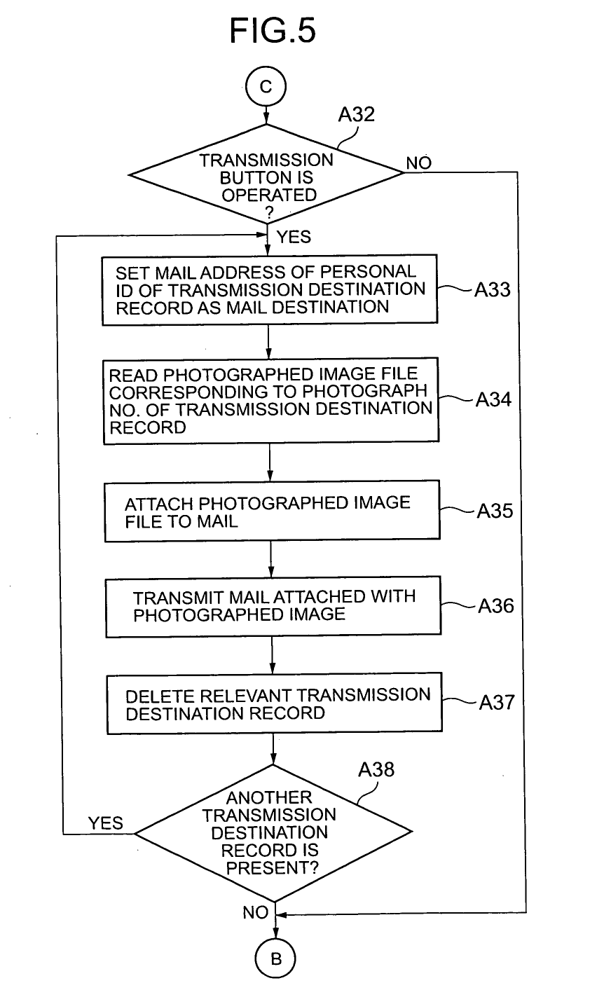

On the other hand, in such a case that the transmission button is manipulated under such a condition that the operation mode is set to the above-described specific mode (step A32 of FIG. 5), the CPU 1 designates one transmission destination record AD, and accesses the registration record RT based upon an item of “personal ID” contained in this designated transmission destination record AD, and then, reads out such a item of “mail address” corresponding to the “personal ID.” Thus, the CPU 1 sets this read “mail address” as a mail destination (step A33). Next, the CPU 1 reads out each item of “photograph No.” from the designated transmission destination record AD, and acquires the relevant image file GF based upon this read item of “photograph No.” (step A34). Thereafter, this photographed image file is converted into a compressed image file, and then the compressed image file is attached to the relevant mail (step A35). Then, after a mail transmission operation has been carried out, the CPU 1 deletes this transmitted transmission destination record AD (step A37). Subsequently, if there are other transmission destination records AD (“YES” in step A38), then the CPU 1 repeatedly executes the above-described transmission process operations while the CPU 1 sequentially designates this transmission destination records AD (steps A33 to A38).

As previously described, in the portable terminal equipped with the camera according to this first embodiment, under such a condition that the CPU 1 stores/manages the registration record RT in which the personal images have been registered in correspondence with the mail addresses every person, in the case that the CPU 1 recognizes that the personal image of the transmission subject is contained in the photographed image by analyzing the photographed image which has been photographed by the camera apparatus 7, the CPU 1 transmits the relevant photographic image to the mail address corresponding to this person in the form of the attached mail. As a consequence, in accordance with the first portable terminal equipped with the camera, the photographed image can be properly transmitted to the transmission destination without executing the specific operation, and such a cumbersome operation is no longer required, and furthermore, it is possible to avoid to forget the transmitting operation of the photographed image. In this cumbersome operation, while the user confirms that what images have been photographed as to each of the photographed images, the user searches the respective mail addresses relevant to these images.

In this case, since the CPU 1 designates the arbitrarily selected person as the transmission subject from the persons who have been registered in the respective registration records RT, the CPU 1 can arbitrarily define the transmission subject, and can change the transmission subject, if necessary.

Further, the transmission destination record AD is formed in which the respective photographed images have been classified depending upon the person, and also, the respective photographed images are transmitted to the mail addresses corresponding to these classified persons. As a consequence, for instance, in such a case that the same person has been photographed plural times, the respective photographed images which have been collected every person can be transmitted in a batch manner.

It should be noted that when the transmission button is manipulated, the CPU 1 attaches the photographed image to the mail with reference to the transmission destination record AD, and then transmits the mail attached with the photographed image in the above-explained first embodiment. Alternatively, for example, the CPU 1 may automatically transmit the mail, while using an empty time period produced when the shutter button is not manipulated and the manipulation of the transmission is not employed as the mail transmission condition. Otherwise, when the present time is reached to a previously set schedule time instant, the CPU 1 may automatically transmit the mail.

In the above-described first embodiment, images of persons have been exemplified as photographic object images. Apparently, any images other than these images of persons maybe alternatively employed. For instance, images of pets, images of articles, and the like may be employed as these photographic object images.

On the other hand, recording media (for example, CD-ROM, floppy disk, RAM card etc.) on which program codes used to execute the above-described respective means with respect to a computer have been recorded may be provided.

In other words, as to such a recording medium having program codes which can be read by a computer, a computer readable recording medium may be provided on which a program has been recorded, and the program is employed so as to realize: a function for storing/managing a previously registered photographic object image in correspondence with a transmission destination; a function for recognizing as to whether or not the previously registered photographic object image is contained in a photographed image by analyzing the photographed image; and a function for transmitting the photographed image to the transmission destination which has been registered in correspondence with the photographic object image in the case that it is so recognized that the photographic object image is contained in the photographed image.

Structure of Second Portable Terminal

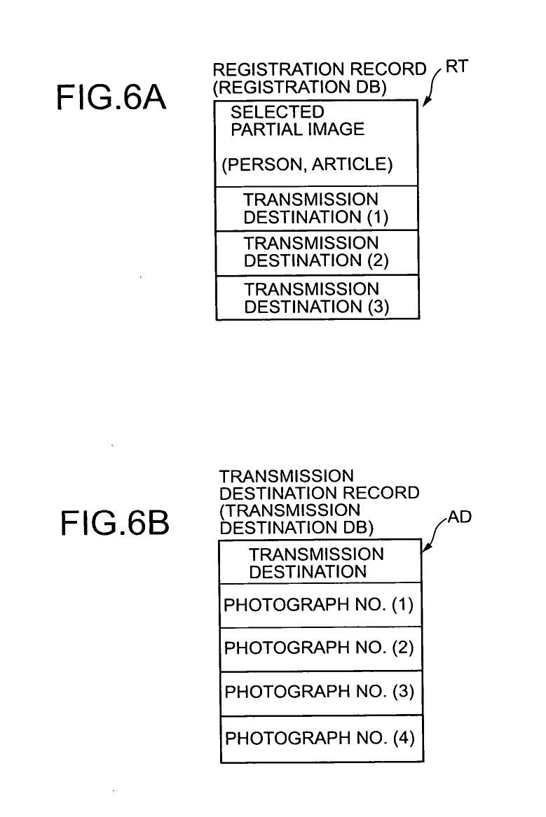

Referring now to FIG. 6 to FIG. 8, a description is made of a portable terminal equipped with a camera, according to a second embodiment of the present invention. As previously explained, in the portable terminal equipped with the camera of the first embodiment, in such a case that the CPU has recognized that an image of a person corresponding to a transmission subject is contained in a photographed image, the CPU has transmitted this photographed image to a mail address corresponding to this person in the form of the attached mail. In a portable terminal equipped with the second embodiment, when a transmission destination of a photographed image is arbitrarily designated, such a photographed image is extracted which contains an image of a photographic object which has been registered in correspondence with this transmission destination. Then, this extracted image is transmitted to the designated transmission destination in the form of a mail. Also, in the above-described first embodiment, the persons and the transmission destinations (mail addresses) have been registered in the registration record RT in an one-to-one correspondence relationship, and further, the transmission destination record AD has been formed in which the respective photographed images have been classified based upon the persons, and then, the respective photographed images have been transmitted to the mail addresses corresponding to these persons. In this second embodiment, a plurality of transmission destinations can be set to the registration record RT in correspondence with persons. In addition, such a transmission destination record AD is formed in which respective photographed images have been classified, depending upon the transmission destinations, and then, the respective photographed images are transmitted, depending upon the transmission destinations.

It should be understood that the same reference numerals shown in the first embodiment will be employed as those for denoting the basically same structural elements, and explanations thereof are omitted. Subsequently, featured portions of the second embodiment will be mainly described.

FIG. 6A is a diagram for illustratively showing a content of a registration record “RT” which constructs a registration database of the second portable terminal equipped with the camera. FIG. 6B is a diagram for illustratively representing a content of a transmission destination record “AD” which constitutes a transmission database of the second portable terminal.

The registration record RT stores and manages “images of photographic objects” and “transmission destinations” in correspondence with each other with respect to each of the photographic objects (persons, articles) which have been previously registered. The registration record RT is constructed in such a manner that a plurality of “transmission destinations” can be stored with respect to each of the photographic objects. In this case, a “photographic object image” corresponds to such a photographic object image (selected partial image) that when an arbitrary photographic object is selected/designated from a photographed image which has been held, this photographic object image is partially extracted from this photographed image. It should also be understood that as the plural “transmission destinations”, there are mail addresses, telephone numbers, and the like. These transmission destinations are both a transmission destination to an appliance installed in the own house, and a transmission destination to a portable terminal, or both the own transmission destination and a transmission destination of a relevant person.

The transmission destination record AD classifies/manages respective photographed images, depending upon transmission destinations. This transmission destination record AD is arranged by that a plurality of “photograph Nos.” can be stored in correspondence with “transmission destinations.”

Photographing Operation/Mail Transmitting Operation of Second Portable Terminal

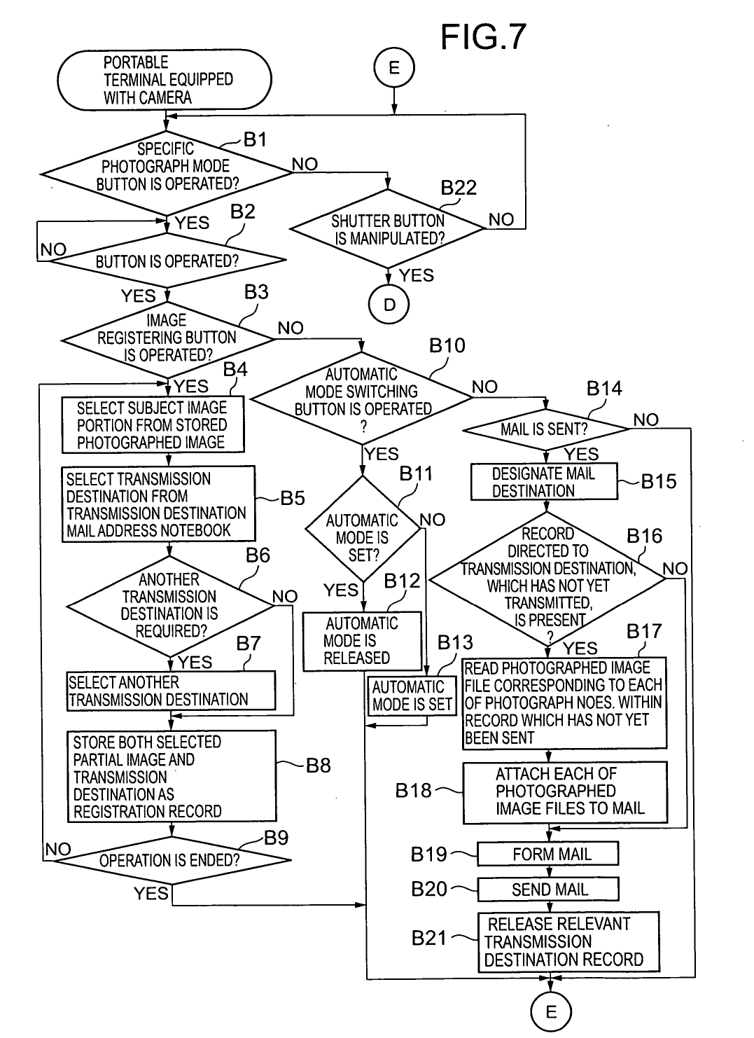

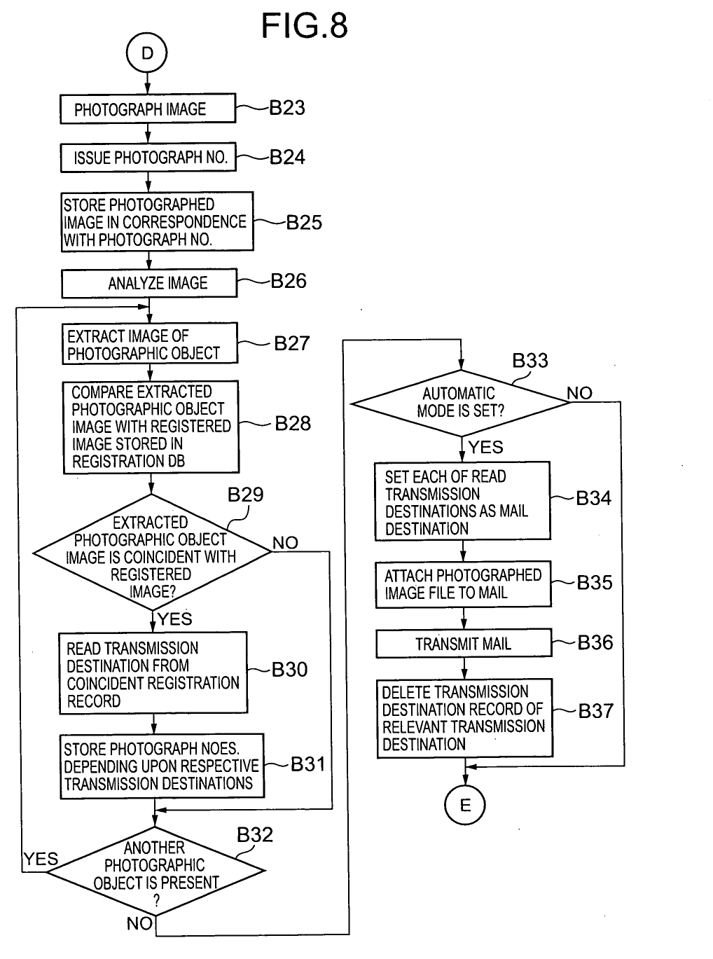

FIG. 7 and FIG. 8 are flowcharts for describing process operations as to a camera photographing operation and a mail transmitting operation of a photographed image, which are executed in the portable terminal equipped with the camera according to the second embodiment.

First, after the button for transferring the camera mode from the normal photographic mode to the specific photographic mode has been manipulated (step B1), the CPU 1 checks as to whether or not another button of this second portable terminal is operated (step B2). When the operated button is the image registering button (step B3), the CPU 1 performs such a process operation for selecting a portion of an image to be transmitted (namely, transmission subject image) from a photographed image which has been stored (step B4). In other words, if an arbitrary photographic object is selected/designated from this photographed image under such a condition that the photographed image which has been stored is read and displayed, an image of this designated portion is extracted/selected as a photographic object image (namely, selected partial image) of a transmission subject.

Next, under such a condition that contents of a transmission mail address notebook (not shown) is displayed in the form of a list, when an arbitrary transmission destination is selected/designated from this list representation, the CPU 1 reads out the designated transmission destination from the transmission destination mail address notebook (step B5). At this time, in such a case that a plurality of transmission destinations are required to be registered (step B6), the CPU 1 sequentially reads out the necessary number of transmission destinations from this address notebook (step B7). When such a selecting operation of the transmission destination is accomplished, the CPU 1 forms a registration record “RT” which contains both the photographic object image (selected partial image) which has been selected/extracted as the transmission subject and the transmission destination acquired from the transmission destination mail address notebook, and then stores/manages this formed registration record RT (step B8).

Subsequently, the above-described registration record producing process operations (steps B4 to B9) are repeatedly carried out every 1 record until a completion of the registering operation is instructed (step B9).

Under such a condition that the registration record is produced/managed every photographic object in the above-described manner, in such a case that the changing button to the automatic mode is manipulated (step B10), the CPU 1 checks as to whether or not the automatic mode has already been set (step B11). This automatic mode corresponds to such an operation mode that a photographed image is set to a transmittable condition. Every time this automatic mode switching button is operated, the automatic mode is repeatedly set/released (steps B12 and B13).

On the other hand, under such a condition that the above-described specific photographic mode is released (reset), when the shutter button is manipulated (step B22), an image photographing operation is carried out in response to this shutter button (step A23 of FIG. 8), and the photograph No. is updated to issue a new photograph No. (step B24), and then, the photographic image to which this new photograph No. has been attached is stored as an image file GF (step B26). Then, the CPU 1 analyzes this stored photographed image (step B26) so as to extract an image of a photographic object which is contained in the photographed image (step B27). In this case, for example, if the photographic object corresponds to a person, then an image of the person where a face is located at a center of this image is extracted. If the photographic object corresponds to a pet, merchandise, or the like, then an entire image of this photographic object is extracted. After the image for one photographic object has been extracted from the photographed image in this manner, while the CPU 1 sequentially reads the registered images (selected partial images) which are contained in the respective registration reads “RTs”, the CPU 1 sequentially compares the extracted image with each of the registered images (step B28), and checks as to whether or not there is such a registered image whose featured portion is made coincident with that of the extracted image (step B29).

As a result, when the registered image whose featured portion is made coincident with that of the extracted image is present, (“YES” in step B29), the CPU 1 reads out all of the transmission destinations from this registration record RT (step B30), and then sets the photograph NOs. into the transmission destination record AD, depending upon the respective transmission destinations (step B31). In this case, if the relevant transmission destination record AD is present (relevant transmission destination record AD has already been formed), then this photograph No. is additionally registered in the relevant record. To the contrary, if the relevant transmission destination record AD is not present, then a transmission destination record AD is newly formed.

Furthermore, since the CPU 1 analyzes the photographed image, this CPU 1 checks as to whether or not another photographic object is contained in this photographed image (step B32). In such a case that a plurality of photographic objects have been photographed in the photographed image, the process operation is returned to the previous step B27. In this step B27, an image portion for another single photographic object is extracted from this photographed image, and thereafter, the above-explained operation is repeatedly carried out.

As a result, when the extracting/comparing process operations are accomplished with respect to all of the photographic objects which have been photographed in this photographed image (“NO” in step B32), the CPU 1 checks as to whether or not the automatic mode is set (step B33). If the automatic mode is released, then the process operation is returned to the first step B1. To the contrary, when the automatic mode is set, the CPU 1 acquires transmission destinations from the respective transmission destination records AD, depending to the respective transmission destinations, to which the “photograph Noes.” have been set in the above-described step B31. Then, the CPU 1 sets each of the transmission destinations as a destination every mail (step B34), and reads out each of the “photograph Noes.” every transmission destination record AD, and also, reads out each of the relevant image files GF based upon this read “photograph No.” Thereafter, the CPU 1 converts each of the photographed image files into a compressed image file, and then, attaches the compressed image file to the corresponding mail (B35) Then, after the mail transmitting operation has been carried out (step B36), the CPU 1 deletes the respective transmission destination records AD which have been mail-transmitted (step B37).

On the other hand, in such a case that the mail transmission button is manipulated (step B14 of FIG. 7) under such a condition that the operation mode is set to the above-described specific photographic mode, the CPU 1 accepts a destination designation of this mail (step B15), and accesses the transmission destination record AD based upon the designated destination, and then checks as to whether or not the relevant transmission destination record AD is present (step B16). In this case, in such a case that the automatic mode has been set, the transmission destination record AD which has already been transmitted has been deleted. To the contrary, when the automatic mode is released, since such a transmission destination record AD which has not yet been transmitted is present, if such a transmission destination record AD of the designated destination is contained in the transmission destination record AD which has not yet been transmitted, the CPU 1 reads out each item of “photograph No.” from this transmission destination record AD, and acquires the relevant image file GF based upon this read item of “photograph No.” (step B17). Thereafter, each of the photographed image files is converted into a compressed image file, and then the compressed image file is attached to the mail of the designated designation (step B18). Then, after a mail text has been formed (step B19), the CPU 1 executes a mail transmitting operation (step B20). Thereafter, the CPU 1 deletes this transmitted transmission destination record AD (step B21).

As previously described, in this second embodiment, the CPU 1 forms such a transmission destination record AD that the respective photographed images which have been photographed by the camera apparatus 7 are classified depending upon the respective transmission destinations, and transmits the respective photographed images in the mail form every transmission destination. As a result, in such a case that the same photographic object is photographed plural times, the respective photographed images which are collected with respect to each of the transmission destinations can be transmitted in the batch manner.

Also, if a plurality of transmission destinations have been set in the registration records RT in correspondence with the same photographic object image, then such a photographed image which contains this same photographic object image is transmitted to the plural transmission destinations respectively, so that the user friendly characteristic of this second portable terminal can be furthermore improved. In other words, for instance, if both a transmission destination to the own home installed appliance and a transmission destination to a portable terminal, or a transmission destination of the owner and a transmission destination to a relevant person are registered as the plural transmission destinations corresponding to the same photographic object, then the photographed image can be transmitted to the plural transmission destinations respectively.

When the destination of the photographed image is arbitrarily designated while the mail is transmitted, the CPU 1 extracts such a photographed image which contains the photographic object image which has been registered in correspondence with this arbitrarily designated transmission destination, and then, transmits the extracted image to the designated transmission destination in the mail form. As a consequence, this photographed image can be properly transmitted to the designated transmission destination by merely and arbitrarily designating the transmission destination. Also, the second portable terminal can avoid such a cumbersome work that while the user confirms that what image has been photographed every photographed image, the user must fine out the respective transmission destinations.

Further, under such a condition that the photographed image which has already been stored is read out to be displayed, when an arbitrary photographic object is selected/designated from this photographed image, the CPU 1 extracts an image of this designated portion as the photographic object image (selected partial image) to be transmitted and then sets the extracted photographic object image to the registration record RT. As a consequence, the photographic object image acquired at the present can be set as the registered image, so that the recognition ratio during the image comparing operation can be improved.

It should also be understood that in the above-explained first and second embodiments, every time the shutter operation is carried out, the photographed image is analyzed in order that the CPU recognizes as to whether or not the registered image is contained in the photographed image, and then, forms the transmission destination record AD. Alternatively, the above-explained image analyzing operation and forming operation of the transmission destination record AD are not carried out every time the shutter button is manipulated, but, for example, may be carried out in such a manner that the respective photographed image which have been stored are sequentially read out which an empty time period during which the shutter button is not manipulated.

Also, it should be noted that in the first and second embodiments, the photographed image is attached to the mail and then the resulting mail attached with the photographed image is transmitted. Alternatively, such a photographed image which has been printed in a color mode may be transmitted by using a facsimile apparatus. The present invention is not limited to transmission modes. Furthermore, not only still images, but also moving pictures may be alternatively transmitted as the photographed image to be transmitted.

Moreover, in the above-described first embodiment and second embodiment, the present invention is exemplified as the portable terminal equipped with the camera. Alternatively, the present invention may be exemplified by employing such an image transmitting apparatus which receives/acquires respective photographed images and transmits the acquired photographed images to transmission destinations, while these photographed images are photographed by a camera apparatus other than the camera of the above-explained portable terminal.

On the other hand, recording media (for example, CD-ROM, floppy disk, RAM card etc.) on which program codes used to execute the above-described respective means with respect to a computer have been recorded may be provided.

In other words, as to such a recording medium having program codes which can be read by a computer, a computer readable recording medium may be provided on which a program has been recorded, and the program is employed so as to realize: a function for storing/managing a previously registered photographic object image in correspondence with a transmission destination every previously registered photographic object; a function executed in such a manner that when a transmission destination of a photographed image is designated during transmission of an electronic mail, such a photographed image is extracted which contains the photographic object image registered in correspondence with the designated transmission destination; and a function for transmitting an electronic mail to which the extracted photographed image has been attached to the designated transmission destination.

Various modifications and changes maybe made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-152583 filed on May 29, 2003 and including specification, claims, drawings and summary. The disclosure of the above Japanese patent application is incorporated herein by reference in its entirety.

1. A photographed image transmitting apparatus for transmitting a photographed image which is photographed by a camera, comprising:
registration information storage means for storing/managing an image of a previously registered photographic object in correspondence with a transmission destination thereof every said previously registered photographic object;
image recognizing means for recognizing as to whether or not said previously registered photographic object image is contained in said photographed image by analyzing said photographed image; and
transmission means for transmitting said photographed image to said transmission destination which has been registered in correspondence with said photographic object image in such a case that said image recognizing means recognizes that said photographic object image is contained in the photographed image.

2. A photographed image transmitting apparatus as claimed in claim 1, further comprising:
designation means for designating a photographic object as a transmission subject, which is arbitrarily selected from a plurality of photographic objects which have been previously registered in said registration information storage means; and wherein:
said image recognizing means includes means for recognizing as to whether or not the photographic object image of the transmission subject designated by said designation means is contained in the photographed image.

3. A photographed image transmitting apparatus as claimed in claim 1, further comprising:
classification means for classifying the respective photographed images into which said photographic object image is contained based upon the respective transmission destinations in such a case that said image recognizing means recognizes that said photographic object image is contained in the photographed image; and wherein:
said transmission means includes means for transmitting the respective photographed images every transmission destination, which are classified by said classification means, depending upon the respective transmission destinations.

4. A photographed image transmitting apparatus as claimed in claim 1, wherein:
said transmission means further includes:
means operated in such a manner that when a plurality of transmission destinations are registered in correspondence with said same photographic object image, the photographed image containing said same photographic object image is transmitted to said plurality of transmission destinations corresponding to said photographic object image.

5. A photographed image transmitting apparatus for transmitting a photographed image which is photographed by a camera, comprising:
registration information storage means for storing/managing an image of a previously registered photographic object in correspondence with a transmission destination thereof every said previously registered photographic object;
extraction means operated in such a manner that when a transmission destination of a photographed image is arbitrarily designated during a transmission of an electronic mail, such a photographed image is extracted which contains said photographic object image registered in correspondence with said designated transmission destination; and
mail transmission means for transmitting the electronic mail attached with the photographed image which is extracted by said extraction means to said designated transmission destination.

6. A photographed image transmitting apparatus as claimed in claim 1, further comprising:
means operated in such a manner that under such a condition that the photographed image which has already been stored is read to be displayed, if an arbitrary photographic object is selected/designated from said displayed photographed image, an image of said designated portion is extracted as a photographic object image of a transmission subject, and then, said extracted photographic object image is registered in said registration information storage means.

7. A recording medium for recording thereon a program for causing a computer to execute:
a function for storing/managing a previously registered photographic object image in correspondence with a transmission destination;
a function for recognizing as to whether or not said previously registered photographic object image is contained in a photographed image by analyzing the photographed image; and
a function for transmitting the photographed image to the transmission destination which has been registered in correspondence with the photographic object image in the case that it is so recognized that the photographic object image is contained in the photographed image.

8. A recording medium for recording thereon a program for causing a computer to execute:
a function for storing/managing a previously registered photographic object image in correspondence with a transmission destination;
a function executed in such a manner that when a transmission destination of a photographed image is designated during transmission of an electronic mail, such a photographed image is extracted which contains the photographic object image registered in correspondence with the designated transmission destination; and
a function for transmitting an electronic mail to which the extracted photographed image has been attached to the designated transmission destination.

9. A photographed image transmitting apparatus as claimed in claim 5, further comprising:
means operated in such a manner that under such a condition that the photographed image which has already been stored is read to be displayed, if an arbitrary photographic object is selected/designated from said displayed photographed image, an image of said designated portion is extracted as a photographic object image of a transmission subject, and then, said extracted photographic object image is registered in said registration information storage means.
